(19) United States
(12) Patent Application Publication
(10) Pub. No.: US 2020/0026149 A1
(43) Pub. Date: Jan. 23, 2020

(54) APERTURE STOP MODULE

(71) Applicant: SAMSUNG ELECTRO-MECHANICS CO., LTD., Suwon-si (KR)

(72) Inventor: Jae Woo JUN, Suwon-si (KR)

(73) Assignee: SAMSUNG ELECTRO-MECHANICS CO., LTD., Suwon-si (KR)

(21) Appl. No.: 16/366,079

(22) Filed: Mar. 27, 2019

(30) Foreign Application Priority Data
Jul. 20, 2018 (KR) 10-2018-0084734

(51) Int. Cl. G03B 9/02

(52) U.S. Cl. CPC G03B 9/02

(57) ABSTRACT

An aperture stop includes: a housing; blades disposed on an object-side surface of the housing to move in a direction perpendicular to an optical axis direction to form a light incident hole having a variable size; and driving bars to move in conjunction with the blades and to rotate with respect to a rotational axis parallel to an optical axis to drive the blades. The blades include a first blade and a second blade moving in opposite directions to each other with respect to the optical axis.

### CROSS-REFERENCE TO RELATED APPLICATION

This application claims the benefit under 35 USC 119(a) of Korean Patent Application No. 10-2018-0084734 filed on Jul. 20, 2018 in the Korean Intellectual Property Office, the entire disclosure of which is incorporated herein by reference for all purposes.

### BACKGROUND

### 1. Field

The following description relates to an aperture stop module.

### 2. Description of Background

Camera modules have been standardly installed in portable electronic devices such as smartphones, tablet PCs, laptop computers, and the like. A mechanical aperture is typically employed in regular digital cameras to adjust the amount of light entering thereinto, according to the surrounding environment. However, in the case of a camera module typically utilized in small products such as portable electronic devices, due to structural characteristics and spatial limitations, it is difficult to provide a separate aperture.

For example, various components included for operating such an aperture may increase the weight of the camera module. Also, if power connection parts necessary for aperture operation, such as coils, are to be incorporated into the aperture, such power connection parts may interfere with vertical movement of a lens when auto-focusing is performed.

Also, installing an aperture stop having various aperture diameters in such a small space may make it difficult to fix the position of a driving part precisely, thus failing to realize aperture diameters precisely.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an aperture stop includes: a housing; blades disposed on an object-side surface of the housing and configured to move in a direction perpendicular to an optical axis direction to form a light incident hole having a variable size; and driving bars configured to move in conjunction with the blades, and to rotate with respect to a rotational axis parallel to an optical axis to drive the blades. The blades include a first blade and a second blade configured to move in opposite directions to each other with respect to the optical axis.

The rotational axis may be disposed on an edge portion of the object-side surface of the housing.

The driving bars may include a first driving bar and a second driving bar extending from the rotational axis, and an angle between the first driving bar and the second driving bar may be less than 90°.

The first blade may move in conjunction with the first driving bar and the second blade may move in conjunction with the second driving bar.

The blades may include a third blade and a fourth blade, the first blade and the fourth blade may be driven in conjunction with the first driving bar, and the second blade and the third blade may be driven in conjunction with the second driving bar.

The rotational axis may extend in the optical axis direction and may be rotated in conjunction with a shape-memory alloy driving motor.

The rotational axis may be connected to a voice coil motor (VCM) driving motor including a magnet and a coil.

The aperture stop may include a guide bump disposed on the object-side surface of the housing.

Each of the blades may include a guide portion into which the guide bump is inserted.

Each of the guide portions may have a shape extended in a movement direction of the respective blade.

Each of the blades may include a same number of guide portions.

Each of the driving bars may include driving bumps, and each of the blades may include a driving hole into which one of the driving bumps is inserted.

Each of the driving holes may be extended in a direction oblique to a rotation direction of the respective driving bar.

Each of the blades may include a cut-out part in a cut-out shape in a predetermined region in which a driving hole of another blade is disposed.

The blades may include a third blade forming a first pair with the second blade and a fourth blade forming a second pair with the first blade, and the first pair and the second pair may move in opposite directions to each other with respect to the optical axis.

In another general aspect, an aperture stop includes a housing; a rotational axis disposed in an edge region of the housing and extended in a direction parallel to an optical axis direction; driving bars connected to the rotational axis to rotate about the rotational axis; and blades. Each blade is connected to one of the driving bars, includes a through hole, and moves in a direction perpendicular to the optical axis direction based on rotation of the rotational axis to form a light incident hole having a variable size.

The blades may include a first blade to move in a first direction perpendicular to the optical axis direction, a second blade to move in a second direction perpendicular to the optical axis direction, a third blade to move in a third direction perpendicular to the optical axis direction, and a fourth blade to move in a fourth direction perpendicular to the optical axis direction.

The aperture stop may be included in a camera module that includes a lens module disposed on an image-side of the aperture stop.

Other features and aspects will be apparent from the following detailed description, the drawings, and the claims.

### BRIEF DESCRIPTION OF DRAWINGS

FIG. 1 is a perspective view of an aperture stop according to an example.

FIG. 2 is an exploded perspective view of an aperture stop according to an example.

FIG. 3 is a perspective view illustrating a driving part (driving bars+a driving motor) of an aperture stop according to an example, assembled into a housing.

FIG. 4 is a perspective view illustrating the form of a driving part (driving bars+a driving motor) of an aperture stop according to an example.

FIGS. 5A and 5B are reference views illustrating operations of a first blade attached to driving bars of an aperture stop according to an example.

FIGS. 6A and 6B are reference views illustrating operations of first and second blades attached to driving bars of an aperture stop according to an example.

FIGS. 7A and 7B are reference views illustrating operations of first to third blades attached to driving bars of an aperture stop according to an example.

FIGS. 8A and 8B are reference views illustrating operations of first to fourth blades attached to driving bars of an aperture stop according to an example.

FIGS. 9A, 9B, 9C, 9D, and 9E are operation views sequentially illustrating an aperture stop according to an example, having a light incident hole from the largest to the smallest.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Herein, it is noted that use of the term “may” with respect to an example or embodiment, e.g., as to what an example or embodiment may include or implement, means that at least one example or embodiment exists in which such a feature is included or implemented while all examples and embodiments are not limited thereto.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

The features of the examples described herein may be combined in various ways as will be apparent after an understanding of the disclosure of this application. Further, although the examples described herein have a variety of configurations, other configurations are possible as will be apparent after an understanding of the disclosure of this application.

Hereinafter, examples will be described with reference to the attached drawings. However, the scope of the following description is not limited by the examples disclosed herein.

An aperture stop according to the examples may be provided in a camera module installed in portable electronic devices such as portable communications terminals, smartphones, and tablet PCs.

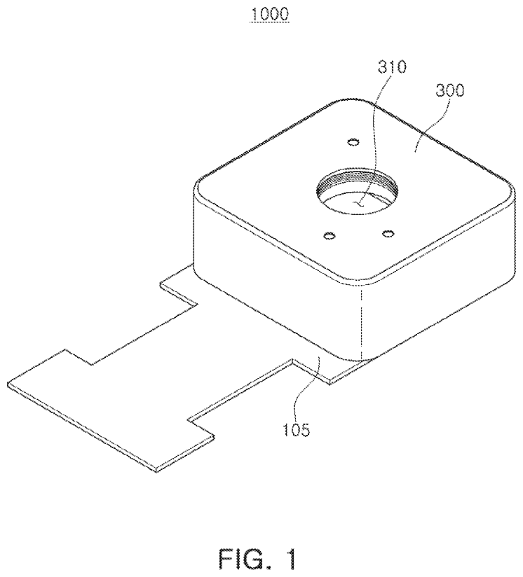

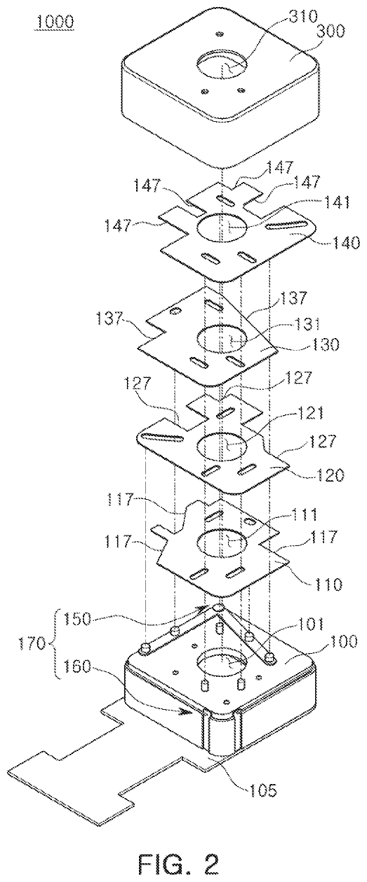

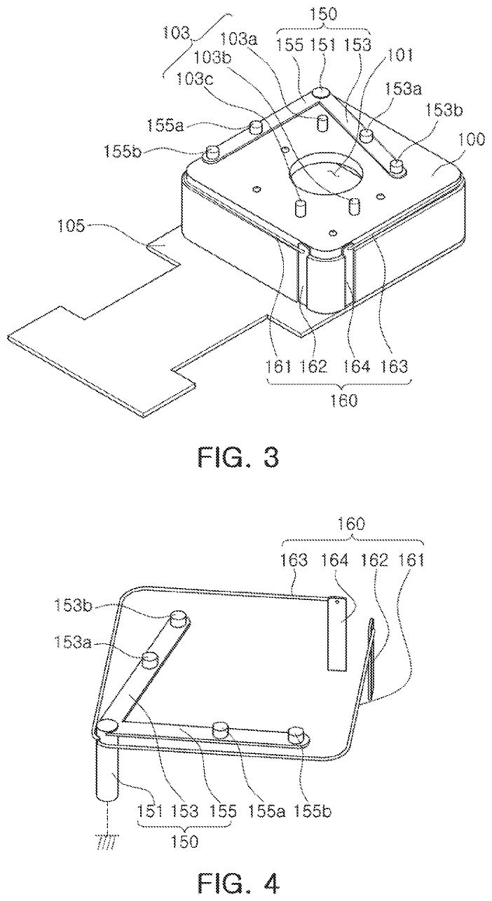

FIG. 1 is a perspective view of an aperture stop according to an example, FIG. 2 is an exploded perspective view of an aperture stop according to an example, FIG. 3 is a perspective view illustrating a driving part (driving bars+a driving motor) of an aperture stop according to an example, attached to a housing, and FIG. 4 is a perspective view illustrating the form of a driving part (driving bars+a driving motor) of an aperture stop according to an example.

Referring to FIG. 1 and FIG. 2, an aperture stop 1000 may include a housing 100, at least two blades 110, 120, 130, and 140 provided on an upper part (object side) of the housing 100, and a blade driving part 170 including a driving pole 150 and a driving motor 160. The aperture stop 1000 may optionally include a cover 300 covering the upper part of the housing 100. A through hole 310 on which a light is incident may be provided on the cover 300.

The housing 100 may be provided in the shape of a box having an open lower part, to be installed on an upper part (object side) of a lens module (not illustrated) provided in a camera module (not illustrated). In the present example, the housing 100 is illustrated as having the shape of a rectangular box; however, the housing 100 may be provided in the shape of a circular box or a polygonal box.

In the housing 100, a through hole 101 on which a light is incident may be provided in parallel to an optical axis. The through hole 101 may be circular, polygonal, or the like, and may be smaller or larger than a largest light incident hole 191 of light incident holes 190 formed by the at least two blades 110, 120, 130, and 140, which will be described hereinafter. If the size of the through hole 101 is smaller than the largest light incident hole 191 of the light incident holes 190, the through hole 101 may correspond to the largest light incident hole 190.

Guide bumps 103-103a, 103b, and 103c for guiding movement of the at least two blades 110, 120, 130, and 140 may be provided on a top surface (an object-side surface) of the housing 100. In the present example, the at least two blades 110, 120, 130, and 140 are described as including four blades. However, the at least two blades may include two or more blades. As the at least two blades 110, 120, 130, and 140 may perform linear movement in a direction perpendicular to the optical axis direction, the guide bumps 103-103a, 103b, and 103c may be provided to guide such movement, and for guiding efficiency, two or more such guide bumps 103-103a, 103b, and 103c may be provided. In particular, at least two of the guide bumps 103-103a, 103b, and 103c, when connected to each other, may be respectively positioned obliquely in a movement direction of the at least two blades 110, 120, 130, and 140. In the present example, there may be provided at least two guide bumps 103-103a, 103b, and 103c, for guiding movement of four blades 110, 120, 130, and 140. In the present example, to facilitate distribution of force, an example including three guide bumps 103-103a, 103b, 103c will be described.

On the top surface of the housing 100, the at least two blades 110, 120, 130, and 140 may be sequentially stacked. The at least two blades 110, 120, 130, and 140 may perform a linear movement so as to move closer to the optical axis or away from the optical axis. In other words, the at least two blades 110, 120, 130, and 140 may respectively include first to fourth through holes 111, 121, 131, and 141 or through grooves, such that when the at least two blades 110, 120, 130, and 140 overlap each other, the various light incident holes 190 can be formed. The at least two blades 110, 120, 130, and 140 may perform a linear movement which causes the respective centers of the first to fourth through holes 111, 121, 131, and 141 to move closer to the optical axis or to move further away from the optical axis. When the respective centers of the through holes 111, 121, 131, and 141 have moved closer to the optical axis, the largest light incident hole 191 may be formed, whereas when the respective centers of the through holes 111, 121, 131, and 141 have moved away from the optical axis, the smallest light incident hole 199 may be formed. The through holes 111, 121, 131, and 141 may have the shape of a circle or a polygon.

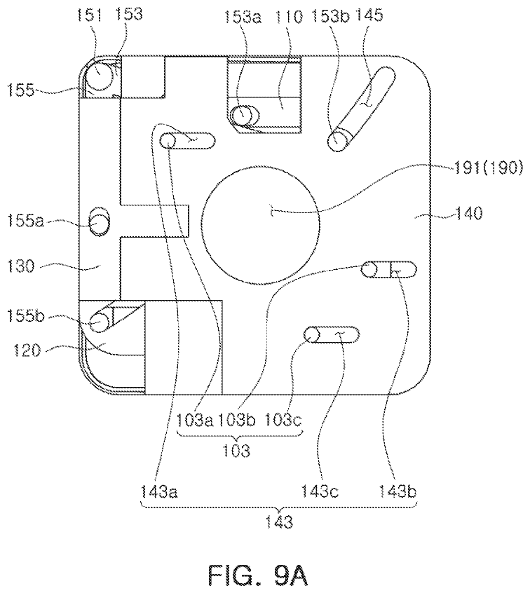

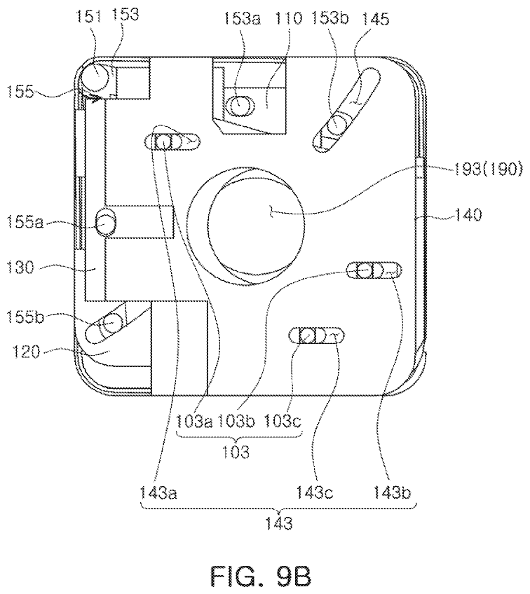

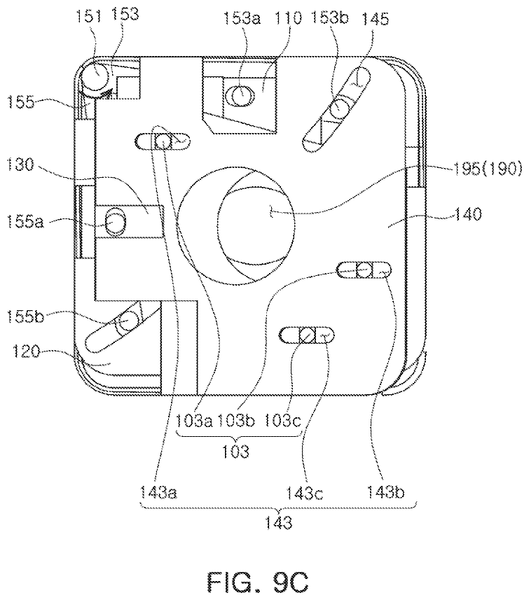

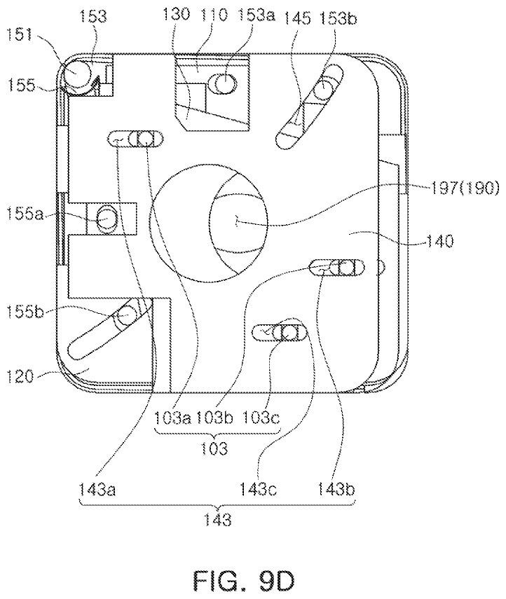

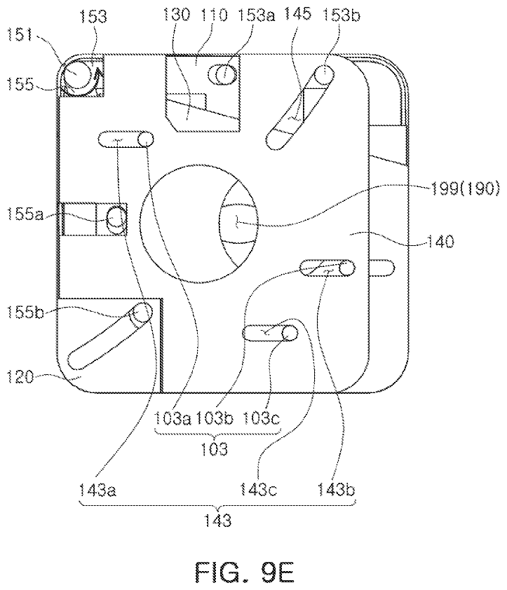

In the present example, the four blades 110, 120, 130, and 140 may be disposed uniformly in four directions, and may respectively perform a linear movement to come closer to the optical axis or to move away from the optical axis (as shown in FIG. 9A to FIG. 9E, the four blades 110, 120, 130, and 140 may perform linear movement in upward, downward, left and right directions as shown in the drawings, to move closer to the optical axis or away from the optical axis).

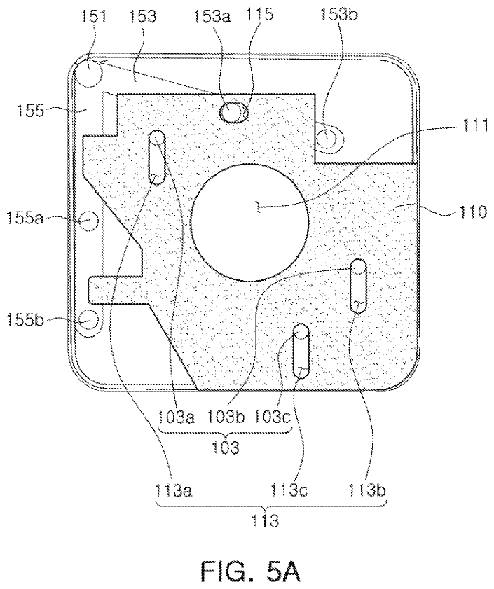

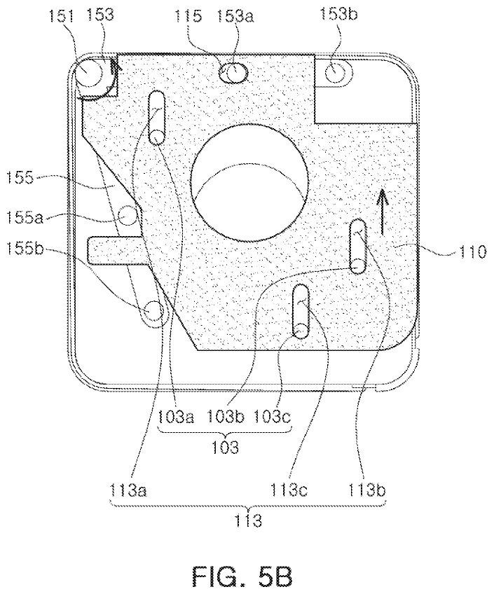

To guide linear movement, the at least two blades 110, 120, 130, and 140 may respectively include guide portions 113, 123, 133, and 143 (shown in FIGS. 5A through 9D) in the shape of grooves or holes, into which the guide bumps 103-103a, 103b, and 103c provided on the top surface of the housing 100 are inserted. Guide portion 113 may include guide portions 113a, 113b, and 113c for receiving guide bumps 103a, 103b, and 103c, respectively. Guide portion 123 may include guide portions 123a, 123b, and 123c for receiving guide bumps 103a, 103b, and 103c, respectively. Guide portion 133 may include guide portions 133a, 133b, and 133c for receiving guide bumps 103a, 103b, and 103c, respectively. Guide portion 143 may include guide portions 143a, 143b, and 143c for receiving guide bumps 103a, 103b, and 103c, respectively. The guide portions 113, 123, 133, and 143 may be respectively elongated in a moving direction of the respective blades 110, 120, 130, and 140, and may be provided on the respective blades 110, 120, 130, and 140 in an amount corresponding to the shape of the guide bumps 103-103a, 103b, and 103c, in positions corresponding to the guide bumps 103-103a, 103b, and 103c. As described above, as the guide portions 113, 123, 133, and 143 are inserted into the guide bumps 103-103a, 103b, and 103c, each of the blades 110, 120, 130, and 140 may be restricted to perform a linear movement in one direction perpendicular to the optical axis.

The at least two blades 110, 120, 130, and 140 may respectively include cut-out parts 117, 127, 137, and 147 in a cut-out shape to prevent interference, in a predetermined region in which driving holes 115, 125, 135, and 145 (shown in FIGS. 5A through 9D) are formed in other blades.

The at least two blades 110, 120, 130, and 140 may move in conjunction with a driving pole 150, which includes at least one driving bar 153 and 155 rotating with respect to a rotational axis 151.

The at least one driving bar 153 and 155 may include first to fourth driving bumps 153a, 153b, 155a, and 155b, and the first to fourth driving bumps 153a, 153b, 155a, and 155b may be respectively inserted into the first and fourth driving holes 115, 125, 135, and 145 provided on the first to fourth blades 110, 120, 130, and 140. The first to fourth driving holes 115, 125, 135, and 145 may be elongated in a direction oblique to a moving direction of the respective first to fourth driving bumps 153a, 153b, 155a, and 155b.

As such, as the at least one driving bar 153 and 155 are rotated with respect to the rotational axis 151, the first to fourth blades 110, 120, 130, and 140, while being restricted to perform a linear movement by the guide portions 113, 123, 133, and 143, and the guide bumps 103-103a, 103b, and 103c, may receive a force to move in one direction as the first to fourth driving bumps 153a, 153b, 155a, and 155b are moved inside the first to fourth driving holes 115, 125, 135, and 145, thus moving in a direction perpendicular to the optical axis.

In the present example, the driving pole 150 may include first and second driving bars 153 and 155 extending from the rotational axis 151, forming an angle less than 90° between the first driving bar 153 and the second driving bar 155. The first driving bar 153 may include the first and second driving bumps 153a and 153b and may move in conjunction with the first and fourth blades 110 and 140, wherein the first driving hole 115 may be inserted into the first driving bump 153a, and the fourth driving hole 145 may be inserted into the second driving bump 153b. The second driving bar 155 may include the third and fourth driving bumps 155a and 155b, and may move in conjunction with the second and third blades 120 and 130. The second driving hole 125 may be inserted into the fourth driving bump 155b, and the third driving hole 135 may be inserted into the third driving bump 155a.

The rotational axis 151 may be provided in an edge portion of the top surface of the housing 100. If the housing 100 has the shape of a polygonal pillar, the rotational axis 151 may be provided in a corner portion thereof.

The blade driving part 170 may include the driving pole 150 and the driving motor 160 rotating the driving pole 150.

The driving motor 160 may include shape-memory alloy (SMA) wires 161 and 163 connected to the rotational axis 151, and first and second electrodes 162 and 164 supplying power to the respective wires 161 and 163. As power is supplied to the first and second electrodes 162 and 164, lengths of the SMA wires 161 and 163 may extend or shrink, thereby rotating the rotational axis 151 of the driving pole 150, and accordingly, the first and second driving bars 153 and 155 connected to the rotational axis 151 may rotate on the top surface of the housing 100. The first and second electrodes 162 and 164 may be connected to a substrate 105 attached to a bottom surface of the housing 100, to receive power.

The SMA wires 161 and 163 may be coiled along a side surface of the housing 100 to ensure a sufficient length that facilitates rotation of the rotational axis 151, or may be disposed such that one ends of the SMA wires 161 and 163 are affixed to the rotational axis 151 while at least portion of the SMA wires 161 and 163 are coiled around the rotational axis 151. For example, to be easily fixed to the rotational axis 151, the SMA wires 161 and 163 may be fixed by having one end portions thereof embedded in the rotational axis 151.

The driving motor 160 is not limited to using a shape-memory alloy, but may use any method capable of providing rotational force. For example, a voice-coil motor (VCM) rotary actuator, a linear motor, or the like may be used.

Referring to FIG. 5A and FIG. 5B, the further the rotational axis 151 of the driving pole 150 is rotated counter-clockwise, the further upward the first blade 110 having the first driving bump 153a inserted into the first driving hole 115 can be moved (FIG. 5A→FIG. 5B).

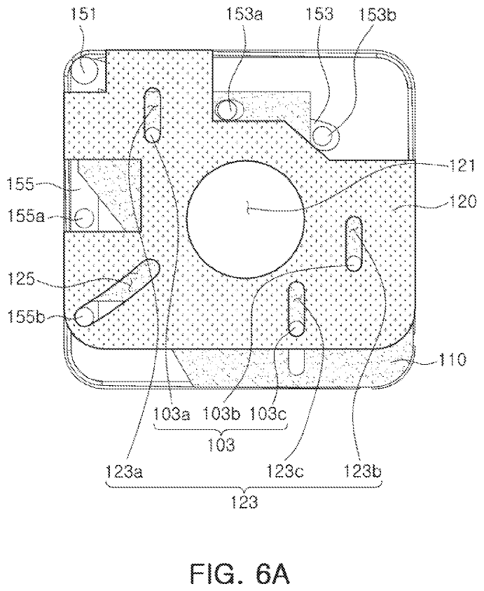

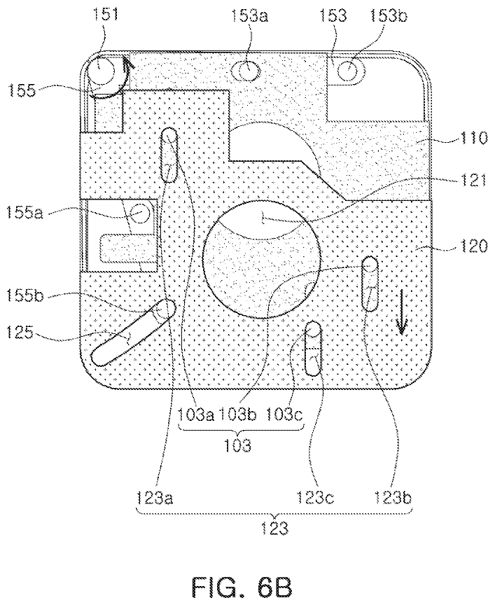

Referring to FIG. 6A and FIG. 6B, the further the rotational axis 151 of the driving pole 150 is rotated counter-clockwise, the further downward the second blade 120 having the fourth driving bump 155b inserted into the second driving hole 125 can be moved (FIG. 6A→FIG. 6B).

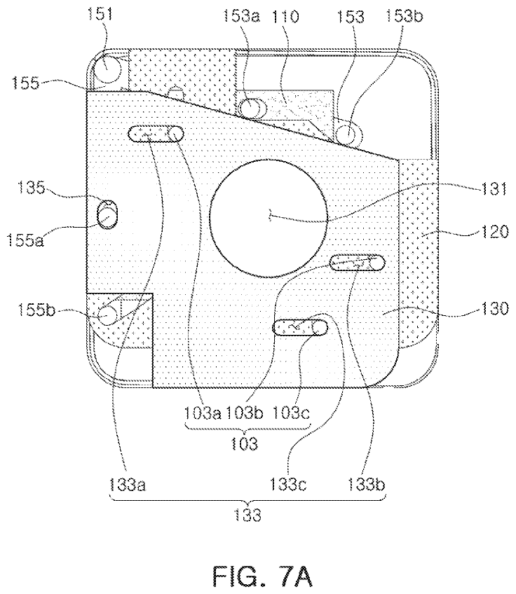

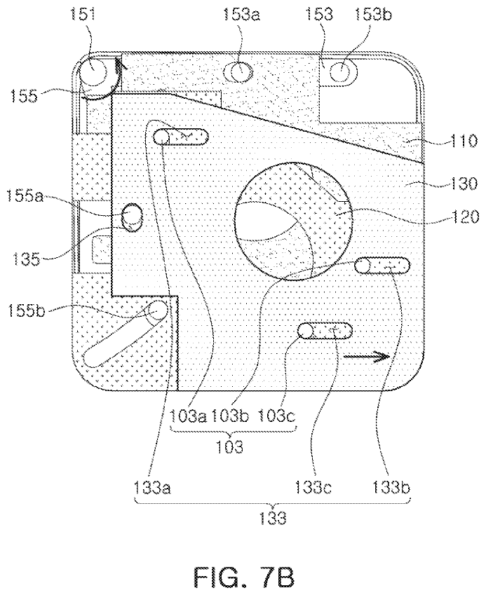

Referring to FIG. 7A and FIG. 7B, the further the rotational axis 151 of the driving pole 150 is rotated counter-clockwise, the further right the third blade 130 having the third driving bump 155a inserted into the third driving hole 135 can be moved (FIG. 7A→FIG. 7B).

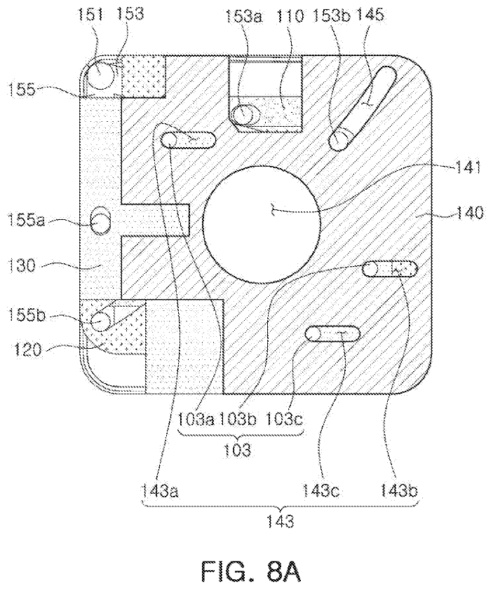

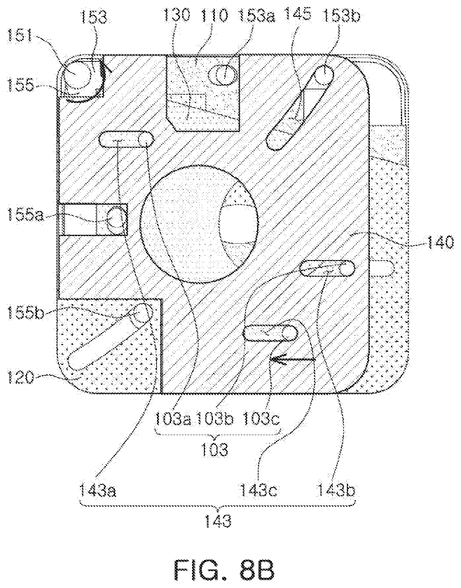

Referring to FIG. 8A and FIG. 8B, the further the rotational axis 151 of the driving pole 150 is rotated counter-clockwise, the further left the fourth blade 140 having the second driving bump 153b inserted into the fourth driving hole 145 can be moved (FIG. 8A→FIG. 8B).

As shown in FIG. 9A to FIG. 9E, the further the rotational axis 151 of the driving pole 150 is rotated counter-clockwise, the light incident hole 190 may become gradually smaller as the first to fourth blades 110, 120, 130, and 140 converge inwardly. Alternatively, the further the rotational axis 151 of the driving pole 150 is rotated clockwise, the light incident hole 190 may become gradually larger as the first to fourth blades 110, 120, 130, and 140 diverge outwardly. For example, FIG. 9A shows an example in which the light incident hole is largest light incident hole 191, FIG. 9B shows an example in which the light incident hole 193 is smaller than the largest light incident hole 191, FIG. 9C shows an example in which the light incident hole 195 is smaller than the light incident hole 193, FIG. 9D shows an example in which the light incident hole 197 is smaller than the light incident hole 195, and FIG. 9E shows an example in which the light incident hole is the smallest light incident hole 199.

The aperture stop may be controlled in a predetermined number of steps (for example, five steps) where each individual step can be realized, or an aperture diameter of the aperture stop may be continuously controlled without determining the number of steps.

As set forth above, an aperture stop according to the examples may maintain performance of an aperture while minimizing an increase in weight of a driving part.

In addition, the aperture stop may precisely realize various aperture diameters.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An aperture stop comprising:
a housing;
blades disposed on an object-side surface of the housing and configured to move in a direction perpendicular to an optical axis direction to form a light incident hole having a variable size; and
driving bars configured to move in conjunction with the blades, and to rotate with respect to a rotational axis parallel to an optical axis to drive the blades,
wherein the blades include a first blade and a second blade configured to move opposite to each other with respect to the optical axis.

2. The aperture stop of claim 1, wherein the rotational axis is disposed on an edge portion of the object-side surface of the housing.

3. The aperture stop of claim 2, wherein the driving bars comprise a first driving bar and a second driving bar extending from the rotational axis, and an angle between the first driving bar and the second driving bar is less than 90°.

4. The aperture stop of claim 3, wherein the first blade is configured to move in conjunction with the first driving bar and the second blade is configured to move in conjunction with the second driving bar.

5. The aperture stop of claim 4, wherein the blades include a third blade and a fourth blade, the first blade and the fourth blade are configured to be driven in conjunction with the first driving bar, and the second blade and the third blade are configured to be driven in conjunction with the second driving bar.

6. The aperture stop of claim 1, wherein the rotational axis extends in the optical axis direction and is configured to be rotated in conjunction with a shape-memory alloy driving motor.

7. The aperture stop of claim 1, wherein the rotational axis is connected to a voice coil motor (VCM) driving motor comprising a magnet and a coil.

8. The aperture stop of claim 1, further comprising a guide bump disposed on the object-side surface of the housing.

9. The aperture stop of claim 8, wherein each of the blades includes a guide portion into which the guide bump is inserted.

10. The aperture stop of claim 9, wherein each of the guide portions has a shape of a groove or a hole.

11. The aperture stop of claim 10, wherein each of the guide portions has a shape extended in a movement direction of the respective blade.

12. The aperture stop of claim 9, wherein each of the blades include a same number of guide portions.

13. The aperture stop of claim 1, wherein each of the driving bars comprises driving bumps, and each of the blades comprises a driving hole into which one of the driving bumps is inserted.

14. The aperture stop of claim 12, wherein each of the driving holes is extended in a direction oblique to a rotation direction of the respective driving bar.

15. The aperture stop of claim 12, wherein each of the blades comprises a cut-out part in a cut-out shape in a predetermined region in which a driving hole of another blade is disposed.

16. The aperture stop of claim 1, wherein the blades include a third blade forming a first pair with the second blade and a fourth blade forming a second pair with the first blade, and the first pair and the second pair move in opposite directions to each other with respect to the optical axis.

17. A camera module, comprising:
the aperture stop of claim 1; and
a lens module disposed on an image-side of the aperture stop.

18. An aperture stop comprising:
a housing;
a rotational axis disposed in an edge region of the housing and extended in a direction parallel to an optical axis direction;
driving bars connected to the rotational axis and configured to rotate about the rotational axis; and
blades, each blade connected to one of the driving bars, comprising a through hole, and configured to move in a direction perpendicular to the optical axis direction based on rotation of the rotational axis to form a light incident hole having a variable size.

19. The aperture stop of claim 18, wherein the blades comprise a first blade configured to move in a first direction perpendicular to the optical axis direction, a second blade configured to move in a second direction perpendicular to the optical axis direction, a third blade configured to move in a third direction perpendicular to the optical axis direction, and a fourth blade configured to move in a fourth direction perpendicular to the optical axis direction.

20. A camera module, comprising:
the aperture stop of claim 18; and
a lens module disposed on an image-side of the aperture stop.
